(19) United States
(12) Patent Application Publication
(10) Pub. No.: US 2015/0058769 A1
(43) Pub. Date: Feb. 26, 2015

(54) ELECTRONIC APPARATUS AND COMPUTER-IMPLEMENTED METHOD

(71) Applicants: Ji Young KIM, (US); BOOGA VENTURES,INC., San Mateo, CA (US)

(72) Inventor: Ji Young Kim, Seongnam-si (KR)

(21) Appl. No.: 14/377,334

(22) PCT Filed: Feb. 4, 2013
(86) PCT No.: PCT/KR2013/000897

§ 371 Date: Aug. 7, 2014

(30) Foreign Application Priority Data
Feb. 7, 2012 (KR) 10-2012-0012275

(51) Int. Cl. G06F 3/0484; G06F 3/0481; G06F 3/0482

(52) U.S. Cl. CPC G06F 3/04842; G06F 3/0482; G06F 3/04817
USPC 715/765

(57) ABSTRACT

An electronic device according to the present embodiment is provided. The electronic device includes a display unit; and a user interface (UI) indicating unit indicating a wheel-structure UI with at least one concentric circle on the display unit, wherein the UI indicating unit includes a wheel logic structure unit setting a coordinate system of X axis and Y axis on the basis of a reference point, setting a sector that is a region divided by the X axis and the Y axis, and arranging at least one wheel UI in the sector, and a wheel control unit enabling the wheel UI to be edited.

### BACKGROUND

The present disclosure relates to a user interface, and more particularly, to a new type of an idea wheel interface.

As a portable electronic device becomes more compact and the amount of information to be stored and processed increases, there is an important challenge to a user interface design that enables a user to easily interact with a device. This is because a response to an action or a behavior of a user, which includes receiving contents by the user and attempting to access a feature or a tool of a device, is unfortunately made through a gateway.

Since electronic devices (for example, a mobile phone) overload functions of the push buttons or provide complex menu systems by adding more push buttons, their data are accessed, stored, manipulated by a user. Thus, such a typical user interface often requires a user to remember a complex key sequence and menu layer.

Such typical many user interfaces including physical push buttons are inflexible and this makes it difficult to configure and/or change user interfaces by a user or an application being executed on a device. Since it takes a relatively long time to remember several key sequences and/or menu layers, such an inflexible property frustrates many users.

Some typical user interfaces may minimize some settings through re-configuration by user. However, modifying such a typical user interface is as cumbersome and complex as using the typical user interface. In particular, a behavior required while configuring such a typical user interface is not often intuitive, and there are some cases where it is difficult to understand an indicator that guides user's actions. Such a challenge becomes frustrating for a user.

Thus, the user interface needs to be more intuitive to a user and needs to smoothly classify and edit stored contents.

### SUMMARY

Embodiments provide a device and a method that enable a user of an electronic device to easily classify and access contents and materials by providing an intuitive and flexible user interface to the user.

In one embodiment, an electronic device includes a display unit; and a user interface (UI) indicating unit indicating a wheel-structure UI with at least one concentric circle on the display unit, the UI indicating unit including a wheel logic structure unit setting a coordinate system of X axis and Y axis on the basis of a reference point, setting a sector that is a region divided by the X axis and the Y axis, and arranging at least one wheel UI in the sector, and a wheel control unit enabling the wheel UI to be edited.

The details of one or more embodiments are set forth in the accompanying drawings and the description below. Other features will be apparent from the description and drawings, and from the claims.

### BRIEF DESCRIPTION OF THE DRAWINGS

FIG. 1 is a block diagram of components of an application module of an idea wheel logic structure according to the present invention.

FIG. 2 is a block diagram of a configuration of an idea wheel logic structure unit according to the present invention.

FIG. 3 is a block diagram of a configuration of an idea wheel control unit according to the present invention.

FIG. 4 is a block diagram of a configuration of an idea wheel generating unit of a configuration of an idea wheel control unit according to the present invention.

FIG. 5 is a block diagram of a configuration of a data object management unit of a configuration of an idea wheel control unit according to the present invention.

FIG. 6 is a block diagram of a configuration of an idea wheel editing/management unit of a configuration of an idea wheel control unit according to the present invention.

FIG. 7 is a block diagram of a configuration of a display device link unit of a configuration of an idea wheel control unit according to the present invention.

FIG. 8 is a block diagram of a configuration of a wheel screen unlocking unit of a configuration of a display device link unit according to the present invention.

FIG. 9 is a view of a user interface (UI) of a wheel structure according to the present invention.

FIG. 10 is a view in which a wheel structure according to the present invention, namely, an idea wheel UI is displayed as a main screen on a smart phone.

FIG. 11 is a view of only specific sector parts in an idea wheel UI of a wheel structure according to the present invention.

FIG. 12 is a view of a drill out function of separating a specific sector from an idea wheel UI of a wheel structure.

FIG. 13 is a view of a spin control function through which an idea wheel UI of a wheel structure changes its position on a display unit.

FIG. 14 is a view in which an UI of a new wheel structure is generated when a folder located at third cell of an A sector in an idea wheel UI of a wheel structure is drilled out, and a view in which an UI of a new wheel structure is generated when the A sector in the idea wheel UI is drilled out.

FIG. 15 is a view of an example in which an idea wheel UI of a wheel structure is displayed on a display unit of an automatic teller machine (ATM).

FIG. 16 is a view of an example in which an idea wheel UI of a wheel structure is displayed on a monitor.

FIG. 17 is a view in which an idea wheel UI accesses an android-based smart phone system structure, and displays a annual ring-shaped wheel as a sheet-form UI by gradually expanding the annual ring-shaped wheel outward from the starting point on a screen of the smart phone.

FIG. 18 is a view of an example of performing unlocking of a smart phone by using an idea wheel UI.

FIG. 19 is a view of an example of unlocking a lock screen of a smart phone by inputting a password by using an idea wheel UI.

FIGS. 20 and 21 are views of examples of executing designated applications according to user's gesture by using an idea wheel UI.

FIG. 22 is a view of automatic alignment of data objects in an idea wheel UI.

FIG. 23 is an example of a block diagram of a portable electronic device.

### DETAILED DESCRIPTION OF THE EMBODIMENTS

Reference will now be made in detail to the embodiments of the present disclosure, examples of which are illustrated in the accompanying drawings.

Prior to describing various embodiments of the present invention with reference to the accompanying drawings, the terms used for describing configurations and operations of the present invention are first defined. However, the definition of the terms is intended to help the readers understand the present invention and the scope of a right of the present invention is not limited thereto.

Data Object: It indicates information that stores a value containing a variable or an array in a specific region, and its examples include texts, music, images, moving pictures and content of their files or folders.

Idea Wheel: It is a user interface (UI) enabling generation, management and control of the data object and includes a plurality of concentric circles, each of circles with different radii each becomes a wheel, and the idea wheel indicates a UI including at least one wheel.

Cell: It is a unit of a storage of the idea wheel in which data objects are stored, cells are grouped to make rows and columns, and the same row of cells make one wheel.

Sector: It is a unit dividing the idea wheel, which may be divided into four sectors by the X axis and the Y axis if the idea wheel is displayed by an XY coordinate system. A user may set or edit the number of sectors and cells present in different wheels may be included in one sector.

Home Portion or Home: It is a region including the center of the idea wheel, keeps the top level object of data to be managed through the idea wheel, and may also be a UI through which a user may select movement to the previous step, depending on the situation.

Idea Flat: It is a UI enabling generation, management and control of the data object and has a structure where a master is arranged on the higher side and a slave is arranged on the lower side while the idea wheel is a circular UI. A user may set/select alignment and arrangement of data with the idea wheel or the idea flat.

Structure of Electronic Device

A description is made below on a structure of an electronic device according to an embodiment of the present invention, in particular a portable electronic device. However, the present invention may also be applied to a desktop PC, a notebook computer, etc, and a portable electronic device that is recently used widely is described as an example.

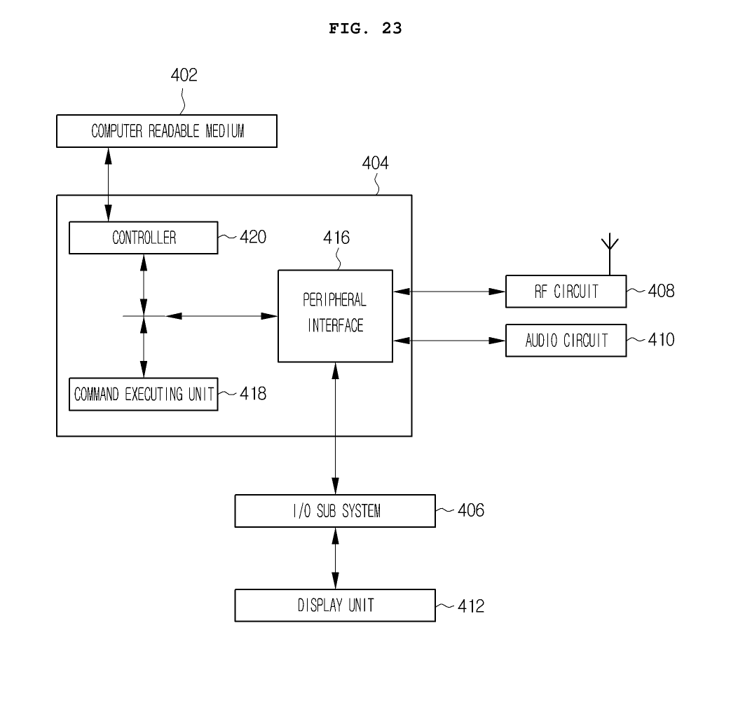

FIG. 23 is an example of a block diagram of a portable electronic device. The portable electronic device 400 may generally include at least one computer readable medium 402, a processing system 404, an input/output (IO) subsystem 406, a radio frequency (RF) circuit 408 and an audio circuit 410. These components may be connected to one another by one or more communication buses or signal lines.

For example, the device 400 may be any portable electronic device that includes a handheld computer, a tablet computer, a mobile phone, a media player, a personal digital assistant (PDA) and two or more combinations thereof. However, the present invention may also be applied to an electronic device including a desktop PC in addition to such a portable electronic device.

The structure illustrated in FIG. 23 is just an exemplary structure of the portable electronic device 400 and may include more or less components or different components than those illustrated. Various components illustrated in FIG. 23 may include one or more signal processing and/or application dedicated integrated circuits and may be implemented as hardware, software, or a combination thereof.

The RF circuit 408 transmits/receives information to/from one or more other devices through a wireless link or a network, includes an antenna system, an RF transceiver, one ore more amplifiers, a tuner, one or more oscillators, a digital signal command executing unit, a compressor/decompressor (CODEC) chipset, a memory, etc, and includes a known circuit performing such functions. In some embodiments, the RF circuit 408 may include time division multiple access (TDMA), code division multiple access (CDMA), global system for mobile communication (GSM), enhanced data GSM environment, wideband CDMA, WiFi, Bluetooth, world interoperability for microwave access (Wi-Max), voice over internet protocol (VoIP), protocol for e-mail, instant messaging and/or short message service or any approximate communication protocol, etc.

The RF circuit 408 and the audio circuit 410 are connected to the processing system 404 through a peripheral interface 416. The interface 416 includes known several components that establishes and maintains communication between peripheral devices and the processing system 404. The audio circuit 410 is connected to an audio speaker and a microphone and includes a known circuit that processes voice signals received from the interface 416 to enable a user to communicate with another user in real time.

In some embodiments, the audio circuit 410 may include a headphone jack. Voice and data information which the RF circuit 408 and the audio circuit 410 receive (from voice recognition or voice command applications, for example) is sent to the one or more command executing unit 418 through the peripheral interface 416. The one or more command executing unit 418 is configured to process various data formats for one or more application programs that are stored in the medium 402.

The term “data” includes texts, graphics, web pages, JAVA applets, widgets, e-mails, instant messages, voices, digital messages or things that are may be used by one or more application programs (web browsers, e-mails, etc.) stored in a video, a widget, or an MP3 medium 402. In some embodiments, the device 400 may upload or download various types of data, for example, files, songs, digital images, videos, e-mails, widgets, instant messages, etc. from the internet through a wireless network or an external port.

The peripheral interface 416 connects IO peripheral devices to the command executing unit 418 and the computer readable medium 402. The one or more command executing unit 418 communicates with the one or more computer readable medium 402 through a controller 420. The computer readable medium 402 may be any device or medium that may store codes and/or data used by the one or more command executing unit 418. The medium 402 includes but is not limited to a memory layer including a cache, a primary memory and a secondary memory. The memory layer may be implemented by using any combination of a random access memory (RAM) (for example, SRAM, DRAM, display data RAM (DDRAM)), a read only memory (ROM), flash, magnetic and/or optical storage device, for example, a disk drive, a magnetic tape, a compact disk (CD), and a digital video disk (DVD). The medium 402 may include a transmission medium for carrying a signal including information (with or without a carrier through which a signal is modulated) that represents a computer command or data. For example, the transmission medium may include a communication network that includes but is not limited to the internet (referred to also as world wide web), an intranet, a local area network (LAN), a wide LAN (WLAN), a storage area network (SAN), a metropolitan area network (MAN), etc.

The one or more command executing unit 418 executes various software components stored in the medium 402 to perform several functions for the device 400. In some embodiments, the software components include operating systems, communication modules (or a set of commands), touch/motion modules (or a set of commands), graphic modules (or a set of commands), one or more applications (or a set of commands), timer modules (or a set of commands), and reconfiguration modules (or a set of commands).

The operating systems (for example, embedded operating systems such as Darwin, RTXC, LINUX, UNIX, X WINDOWS or VxWorks) include drivers for controlling and managing various processes, command sets, software components and/or general system tasks (for example, for managing a memory, a storage device, a power supply, etc.) and facilitates communication between various hardware and software components.

The communication modules facilitate communication with other devices through one or more external ports or the RF circuit 408 and include various software components for processing data received from the RF circuit 408 and/or the external ports. The external ports (for example, USB, FireWire™, etc.) may be connected to other devices directly or indirectly through a network (internet, wireless LAN, etc.).

The graphic modules include known various pieces of software for rendering, animating and displaying graphic objects on a display screen of a touch sensing display unit 412. The term “graphic objects” include texts, web pages, icons, digital images, animation, etc. without limitation and include any objects that may be displayed to a user.

One or more application may include any application installed in the device 400, including a browser, an address book, a contact list, an e-mail, instant messaging, word processing, keyboard emulation, widget, JAVA supporting application, encryption, digital rights management, voice recognition, voice duplication, position determining functions (provided by global positioning system (GPS), for example), or a music player (which plays music stored in one or more files such as MP3 or advanced audio coding (AAC) files) without limitation.

The I/O subsystem 406 is connected to the touch sensing display unit 412 and one or more physical control devices (for example, a push button, a switch, a dial, an light emitting diode (LED), etc.) that perform and control various functions, for example, power control, speaker volume control, ring tone loudness, keyboard input, scrolling, hold, menu, screen lock, communication clearing and ending functions. The display unit 412 may be configured as a touch system that recognizes a touch operation of a user or a stylus pen as a command.

That is, the display unit 412 displays visual outputs to a user through a graphic user interface (GUI). The visual outputs may include texts, graphics, and combinations thereof. Some or all of the visual outputs may correspond to UI objects. The display unit 412 may receive an input from a user on the basis of haptic and/or tactile sensation. The display unit forms a touch sensing surface from which a user input is received.

In some embodiments, the peripheral interface 416, the one or more command executing unit 418, and the memory controller 420 may be implemented on single chip such as the processing system 404. In some other embodiments, they may be implemented as separate chips.

An idea wheel based UI that may be applied to the portable electronic device described above will be described in detail below.

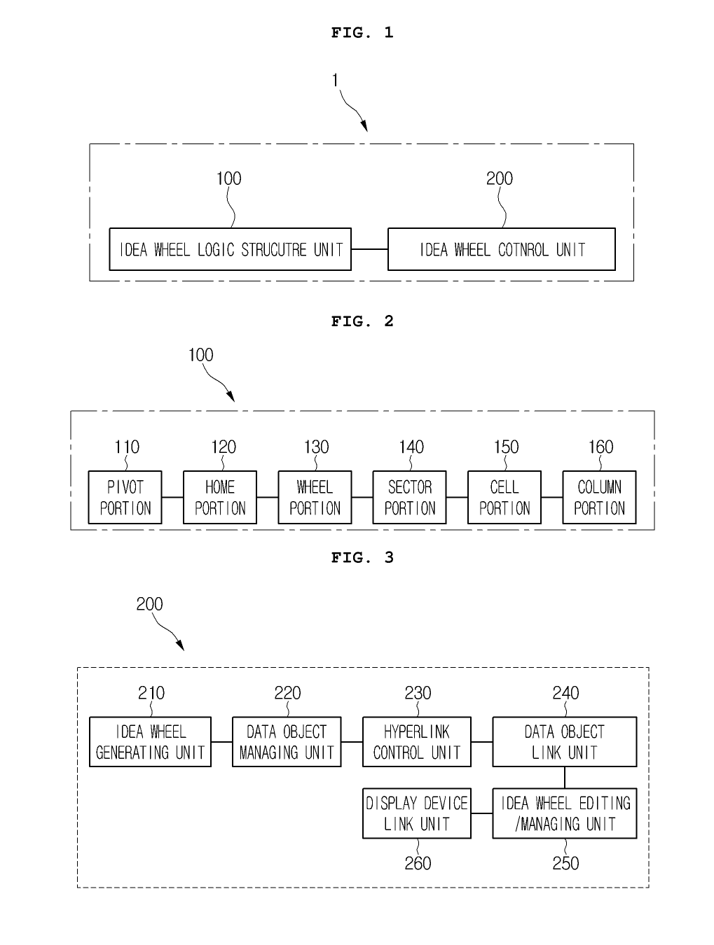

FIG. 1 is a block diagram of components of an application module of an idea wheel logic structure according to the present invention, and includes an idea wheel (IW) application 1 that generates an idea wheel that gradually expands a annual ring-shaped wheel outward from the starting point on a display screen of a display device that includes a smart phone, a PC monitor, a cash dispenser, or a TV monitor.

The IW application module 1 includes an IW logic structure unit 100 and an IW control unit 200.

First, the IW logic structure unit 100 according to the present invention will be described.

IW Logic Structure Unit

The IW logic structure unit 100 plays a role in forming a plurality of annual ring-shaped wheels at intervals from the starting point while a coordinate system of X axis and Y axis is set around the starting point, forming sectors on the basis of the coordinate system of X axis and Y axis, and arranging data on a cell basis in each wheel.

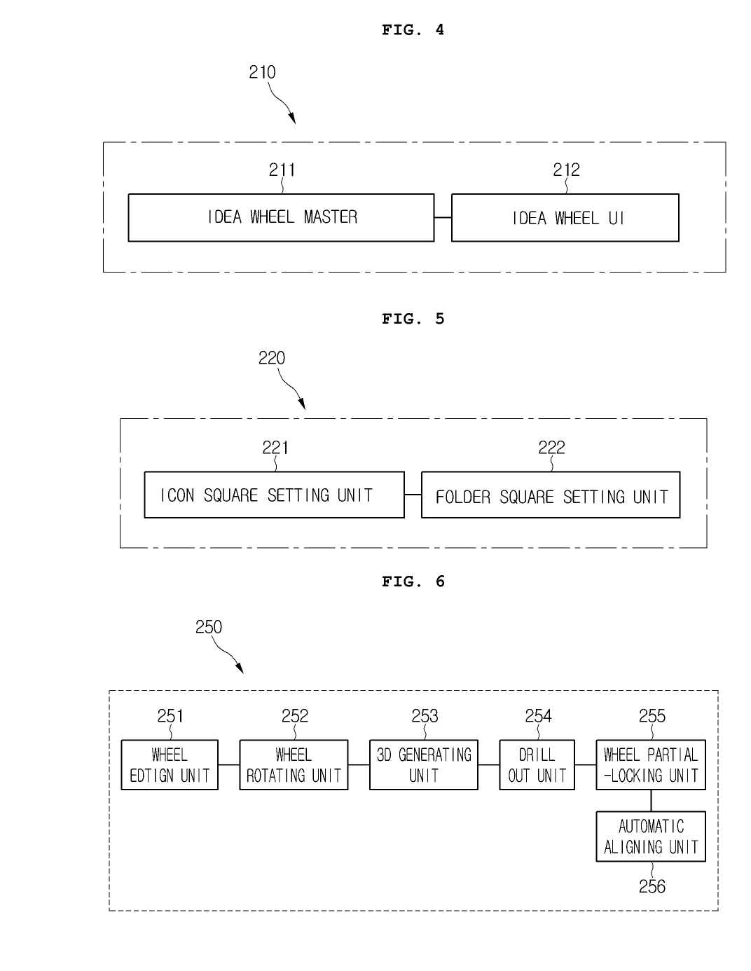

As illustrated in FIGS. 2 and 9, it may be said that the logic structure unit 100 of the IW that is a UI according to the present invention includes a pivot portion 110, a home portion 120, a wheel portion 130, a sector portion 140, a cell portion 150, and a column portion 160. However, names of these components are given to describe operations of the logic structure unit. The logic structure unit does not necessarily include these components that are just intended to describe functions or operations.

The pivot portion 110 is formed in a cross shape of X axis and Y axis around the starting point and plays a role in setting the central axis of a rotating direction.

It selects and sets any one of +X axis, −X axis, +Y axis, and −Y axis as the central axis.

In this case, the central axis means a reference axis of a rotating direction.

The home portion 120 plays a role in displaying an item name of a master on the starting point. The master includes a higher folder and an higher file. In addition, the home portion may perform a widget function that enables executable app icons to be executed and the widget portion performing such a function plays a role in directly activating a corresponding application without passing through a web browser of a PC, a mobile phone, a blog or a cyber community.

Such a widget is a GUI that more smoothly supports interaction of a user with applications or operating systems, and becomes a mini application that executes an application with an IW logic structure immediately after a mouse clicking or hand touch operation.

For example, the widget is a small-sized application that contains useful functions such as weather, a calculator, or a watch and various kinds of information (content), and is made to enable a corresponding service to be immediately used through only a clicking operation without passing a web browser because the widget is made in a shortcut icon type and to be able to be copied or downloaded to a PC, a mobile phone, a blog, a cyber communication or a personal homepage.

The wheel portion 130 are gradually expanded in annual ring shape outward from the home portion and plays a role in setting a rank that is a cell-based display object of a data object.

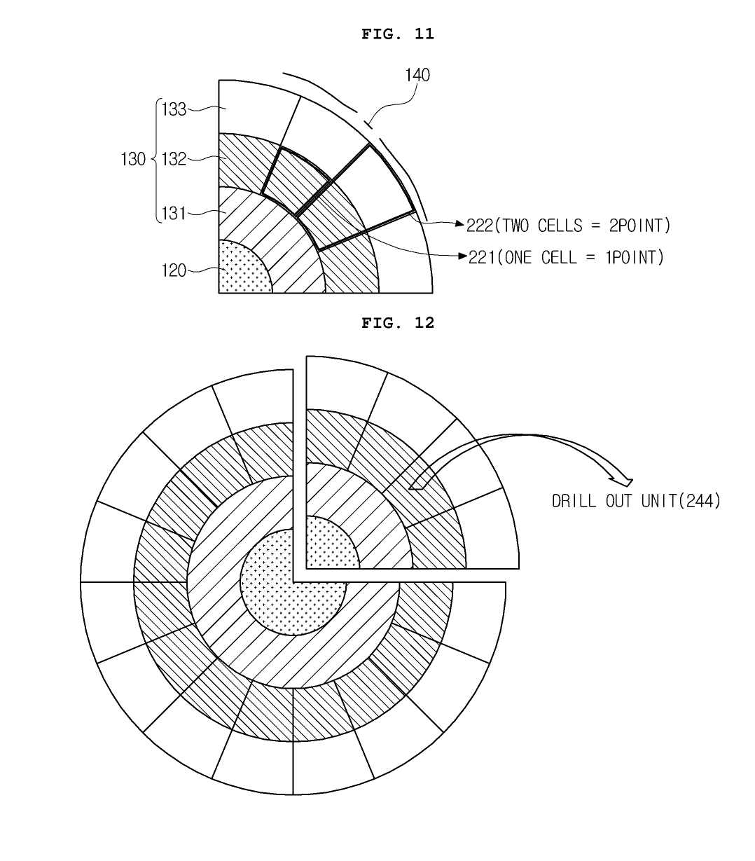

For example, as illustrated in FIG. 11, the wheel portion may include a first wheel 131 which is formed in a first annual ring shape around the starting point of the home portion, a second wheel 132 which is formed in a second annual ring shape outside the first wheel, and a third wheel 133 which is formed in a third annual ring shape outside the second wheel.

In the accompanying drawings of the present invention, the wheel portion is generally illustrated as having three wheels of the first to third wheels, which enables a user to see it on a screen of a portable electronic device such as a smart phone without any additional operation. However, there is no need to limit to examples of the drawings and IWs with various sizes and any number of wheels may be used.

In FIG. 10, the first wheel may include four cells and it may be represented that folders or icons are stored in each cell. The second wheel may include 16 cells and an image of a folder or an icon may be displayed in each cell. In addition, the third wheel may include 16 cells and an image of a folder or an icon may be displayed in each cell.

Through part of the idea wheel illustrated in FIG. 11, a total of 32 icons may be displayed on one screen through the second and third wheels in the case of the entire idea wheel.

If a folder is formed in each of the first to third wheels, the folder formed in the first wheel is set as an higher folder that is on an higher part than the folders in the second and third wheels, the folder formed in the second wheel is set as an intermediate folder that is on a lower part than the folder in the first wheel and on an higher part than the folder than the third wheel, and the folder in the third wheel is set as a lower folder that is on a lower part than the folders in the first and second wheels.

The folder is set by a folder square setting unit as a two point display area that corresponds to two cells of the IW, as illustrated in FIG. 11.

The icon is set by an icon square setting unit as one point display area that corresponds to one cell of the IW, as illustrated in FIG. 11.

The wheel portion according to the present invention is generated as two or more depending on a wheel counter value of the IW generating unit.

Meanwhile, the sector portion 140 of the logic structure unit plays a role in forming a sector shape between the X axis and the Y axis, in grouping a plurality of data objects included in the sector shape to set a sector that is a display object of a cell-based data object, and in generating a auxiliary sector reference line in the wheel portion.

The sector portion has the Y axis as the central axis and includes a la sector whose central axis is +Y axis and which is formed in a sector shape between the +X axis and the +Y axis, a 2a sector that is formed in a sector shape between the +X axis and the −Y axis, a 3a sector that is formed in a sector shape between the −Y axis and the +X axis, and a 4a sector that is formed in a sector shape between the −X axis and the +Y axis,

The sector portion is generated as two or more depending on a sector counter value of the IW generating unit.

The cell portion 150 plays a role in generating, through intersection of the wheel portion with the auxiliary sector reference line, a trapezoidal cell that is a unit object of a data object.

Each of these cells becomes a unit of a storage of data which a user wants to store. For example, a user writes a memo and records schedules in the cell, and the cell becomes data input spaces of unit objects displayed as images.

In addition, the cell portion may display positional information of the IW generating unit as rows and columns.

The column portion 160 plays a role in setting a column that is a display object of a cell-based data object, when wheel-rotating cells clockwise or counter-clockwise on the basis of the central axis.

For example, if there are two cells in the 3a wheel of the la sector on the basis of the central axis in the IW, a cell positioned at a first part on the basis of the central axis is referred to as a first column, and a cell positioned at a second part is referred to as a second column.

The column portion is generated as two or more depending on a column counter value of the IW generating unit.

The IW logic structure unit 100 according to the present invention may generate an IW logic structure with an IW because it includes the pivot portion 110, the home portion 120, the wheel portion 130, the sector portion 140, the cell portion 150, and the column portion 160. In addition, there is no limitation on expanding IW because continuity and consistency are maintained due to such an IW based logic structure, and it is possible to continuously and consistently form data objects that are included in the home, sector, and wheel portions of the IW.

Next, the wheel control unit 200 according to the present invention will be described.

IW Control Unit

The idea wheel control unit 200 accesses data objects from the starting-point wheel to the outer wheel of the IW logic structure unit to set the data object in the starting-point wheel as a master and the data object in the outer wheel as a slave.

In addition, the IW control unit plays a role in controlling the IW logic structure to enable it to be displayed on a screen without any additional operation and in controlling the IW logic structure so that the IW logic structure is generated/edited/wheel-rotated through a control action depending on an event value set to a data object.

As illustrated in FIG. 3, the IW control unit 200 includes an IW generating unit 210, a data object managing unit 220, a hyperlink control unit 230, a data object link unit 240, an IW editing/managing unit 250, and a display link unit 260, depending on its function.

1. IW Generating Unit 210

The IW generating unit 210 plays a role in setting a title of an IW logic structure, a counter value of a sector, a counter value of a wheel, and a column counter value in the sector and then generating on a display screen as a UI, an IW of which annual ring-shaped wheels are gradually expanded outward from the starting point.

As illustrated in FIG. 4, the IW generating unit may include an IW master 211 and an IW UI 212.

The IW master 211 plays a role in activating an input frame on a display screen to set a title of an IW logic structure, a counter value of a sector, a counter value of a wheel, and a column counter value in the sector.

The IW generating unit presets the number of sectors, the number of wheels, the number of columns of an IW that is displayed on the display screen, sets them as reference values, standardizes and activates them as a main screen.

For example, as illustrated in FIG. 10, it is possible to standardize as a main screen, an IW in which the number of sectors is set as four, the number of wheels is set as three, and the number of columns in one sector is set as eight and to display it.

The IW master 211 plays a role in setting the number of wheels of a unlocking IW that is activated on an initial screen (start screen) of a display device, and in setting sector/wheel based locking.

In addition, if one or more IWs are used in one instrument, the IW master plays a role in setting default and activating only a specific IW depending on capacity and rate of the instrument.

The IW UI 212 displays, according to a title of a logic structure, a counter value of a sector, a counter value of a wheel, and a column counter value in the sector input by a user, a UI that includes that includes annual ring-shaped wheels.

2. Data Object Managing Unit 220

The data object managing unit 220 plays a role in forming and displaying data objects included in the home, wheel, sector, and cell portions of an IW on a display screen as icons or folders one to one, in setting a display area occupied by cell to the displayed icon or folder, and in adding, modifying and deleting the data objects.

In this case, the data objects may be texts, music, sounds, images, icons, moving pictures, files, folders, or contents and may be various kinds of files.

The data object managing unit 220 includes an icon square setting unit 221 and a folder square setting unit 222 as illustrated in FIG. 5.

The icon square setting unit 221 plays a role in setting a 1 point display area corresponding to one cell of an IW to an icon of the IW displayed on a display screen as illustrated in FIG. 11.

The folder square setting unit 222 plays a role in setting a 2 point display area corresponding to two cells of an IW to a folder of the IW displayed on a display screen as illustrated in FIG. 11.

As such, the data object managing unit 220 according to the present invention may set different display areas if a data object is displayable as an icon of data to be stored and if the data object is a folder that is a group of these objects.

For example, the icon square setting unit 221 may set a 1 point display area corresponding to one cell of an IW to an icon and a 2 point display area corresponding to two cells of the IW to a folder. In addition, an IW in which the number of sectors is four, the number of wheels is three, and the number of columns in one sector is eight may be activated as a standard main screen.

3. Hyperlink Control Unit 230

The hyperlink control unit 230 plays a role in hyper-linking and accessing a data object made on the basis of a wheel, a sector, and a cell of an IW to an internet site and an application. For example, the hyperlink control unit is a browser application for allowing a user to access a website and may be browsing software such as Safari, Chrome, Explorer.

The hyperlink control unit is configured to link a data object made on the basis of a wheel, a sector, a cell of an IW to a data object included in a wheel, a sector, a cell of another IW, or an internet site and an application.

A user executes or activates hyperlink by clicking underlined components of a data object made on the basis of a wheel, a sector, a cell of an IW or components (linked components) displayed as different colors from the other parts of a data object.

Thus, it is possible to select and search a connection of a component of a data object made on the basis of a wheel, a sector, a cell of the same IW to a data object included in a wheel, a sector, a cell of another IW, and it is possible to select and search a connection to an internet site and an application program on a world wide web (WWW) server in another internet host.

The hyperlink control unit may be included in texts, music, sounds, images, moving pictures, files, folders, and contents through tags of hypertext-type data object markup language such as standard generalized markup language (SGML) and hypertext markup language (HTML).

4. Data Object Link Unit 240

The data object link unit 240 plays a role in taking a specific data object to an internet site and application program hyperlinked through the hyperlink control unit and outputting it to the data object managing unit.

5. IW Editing/Managing Unit

The IW editing/managing unit 250 plays a role in editing and wheel-rotating a data object included in the entire display screen consisting of an IW or a home portion, a wheel, a sector, a cell of an IW.

For example, as illustrated in FIG. 6, the IW editing/managing unit may include functions of a wheel editing unit 251, a wheel rotating unit 252, a 3D generating unit 253, a drill out unit 254, a wheel partial-locking unit 255, and an automatic aligning unit 256.

The wheel editing unit 251 plays a role in inserting, adding, and deleting a data object included in the entire display screen consisting of an IW and a home portion, a wheel, a sector, a cell of an IW.

The wheel rotating unit 252 plays a role in rotating a wheel partially or wholly.

The 3D generating unit 253 plays a role in transforming an IW or an idea flat activated on a sheet screen into 3D and three-dimensionally activating it.

As illustrated in FIG. 12, the drill out unit 254 plays a role in entirely extracting a wheel of a specific part where there is an important data object in the same sector of an IW, and a slave of a cell including the wheel of the specific part and in generating a new idea wheel. The present embodiment refers to as the drill out unit but it may be referred to as a function of generating a sector selected in response to a user input (gesture) as a new IW.

The wheel partial-locking unit 255 plays a role in setting a password to the entire IW, a specific sector, or a specific wheel for encryption and partially locking them. If a UI of the present embodiment run as an application of a smart phone, the wheel partial-locking unit may be a lock/unlock unit of a corresponding application, and if the UI of the present embodiment is implemented as an operating system (OS) of the smart phone, the wheel partial-locking unit may be a lock/unlock unit of a system.

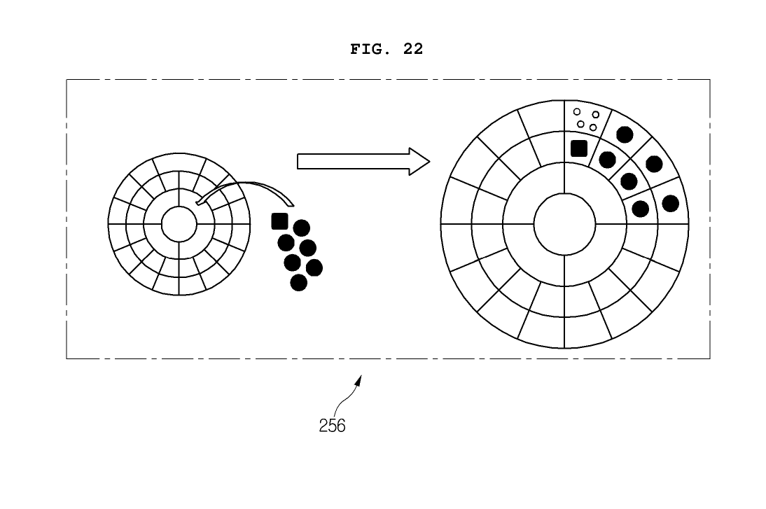

As illustrated in FIG. 22, the automatic aligning unit 256 plays a role in automatically arranging a data object including an app icon or a folder icon in cells of second and third wheels in order if the data object enters a first wheel of an IW in which a sector name is input. Even if a user does not calculate storage capacity by sector, automatic alignment is performed.

6. Display Link Unit 260

The display link unit 260 is connected to a display device, and plays in outputting an IW on a screen of the display device as a UI and instructing an IW displayed on the screen according to an event value set to a function key of the display device in conjunction with the function key to perform a control action on movement/position change/rotation/display.

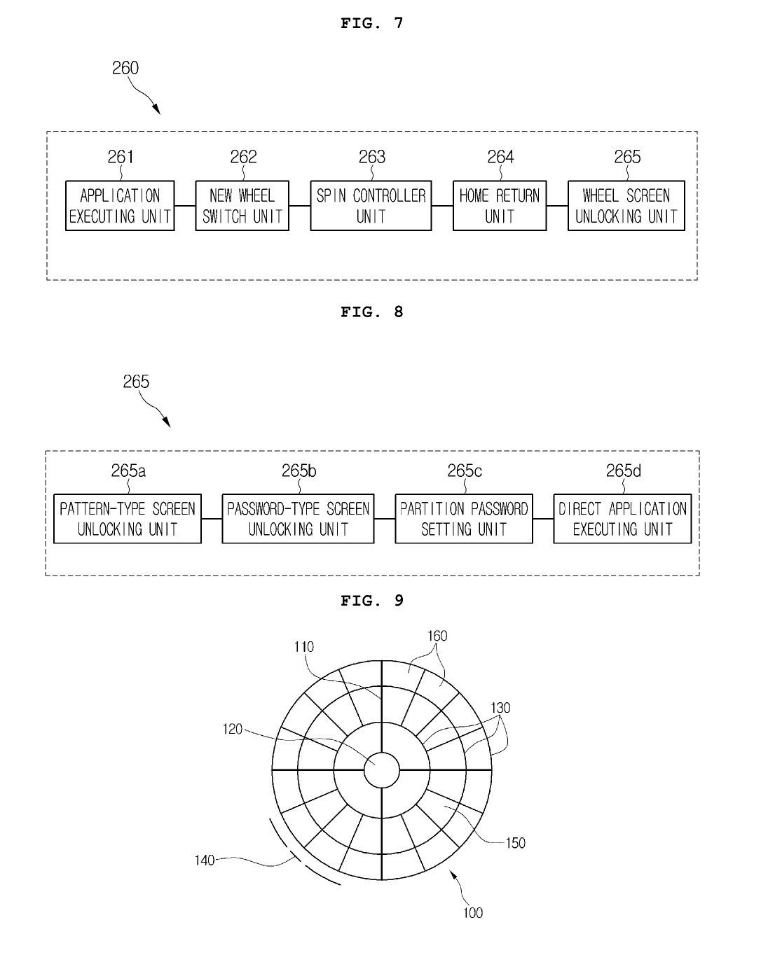

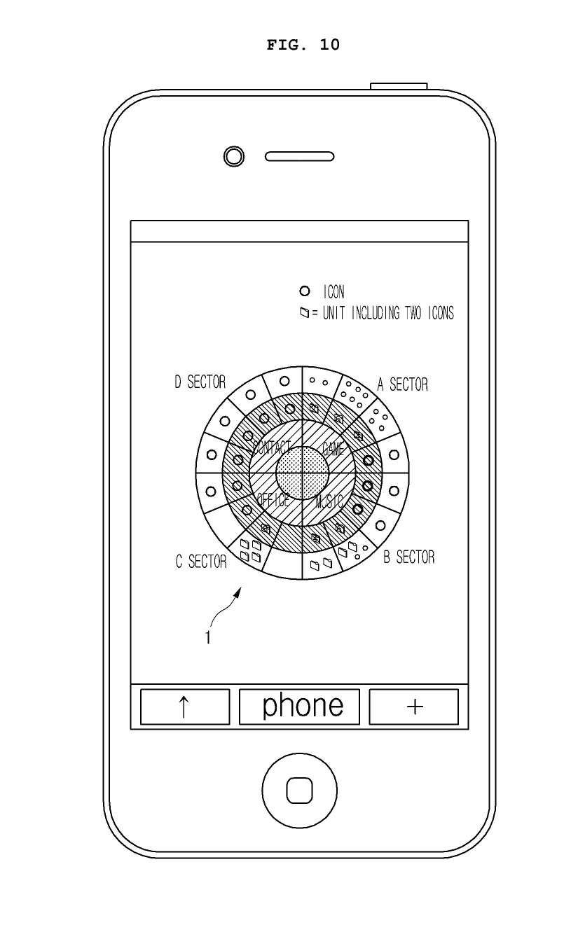

As illustrated in FIG. 7, the display link unit may perform functions of an application executing unit 261, a new wheel switch unit 262, a spin controller unit 263, a home key return unit 264, and a wheel screen unlocking unit 265, for example.

If an icon formed on a cell of IW is clicked on a display screen, the application executing unit 261 plays a role in performing a specific application corresponding to the icon by taking a control action according to an event value set to the icon.

In this case, the specific application may be an execution application that executes weather, stock, time, a schedule, an English dictionary, a memo, a message (whatsapp), a phone, or the internet.

If a folder formed on a cell of an IW is clicked on a display screen, the new wheel switch unit 262 plays a role in setting the folder clicked on a new IW as a master, setting a lower folder and an icon included in the clicked folder as a slave, and one-to-one enumerating them in a wheel, a sector, a column of the new IW clockwise in order.

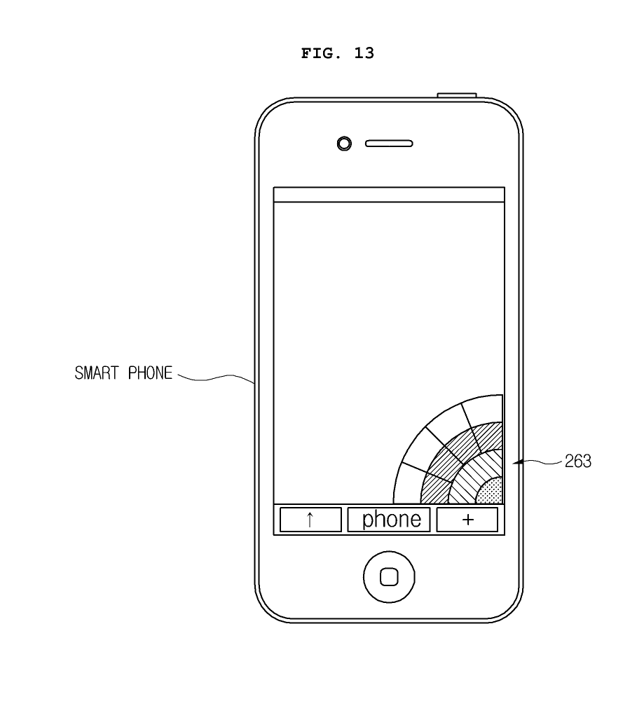

The spin controller unit 263 enables an IW UI displaying files stored in an electronic device to be disposed on the corner of a screen, if the screen is small as in a smart phone. As illustrated in FIG. 13, the spin controller unit positions a specific sector on one side of the lower part of the screen and makes a wheel and a sector spin rotation around a home portion. In addition, the spin controller unit plays a role in controlling to move the specific sector from an IW displayed on the current screen to a sector of another IW if the specific sector is selected, and to move a specific cell from an IW displayed on the current display screen to a cell of another IW if the specific cell is selected.

The home key return unit 264 plays a role in returning from an IW with a lower folder, namely, a data object of a slave displayed on the current screen, to an IW with the top level folder, namely, a data object of a master.

The wheel screen unlocking unit 265 plays a role in activating an unlocking IW on a start screen and recognizing start, intermediate, and end points of cells of the unlocking IW touched through a pattern or a password to immediately execute a corresponding application by taking a control action according to a set event value simultaneously with unlocking.

Various unlocking gestures may be set by a pattern-type screen unlocking unit 265a and a password-type screen unlocking unit 265b

As illustrated in FIG. 18, the pattern-type screen unlocking unit 265a plays a role in previously setting a specific pattern structure as a unlocking signal and unlocking a screen if matching the set pattern structure.

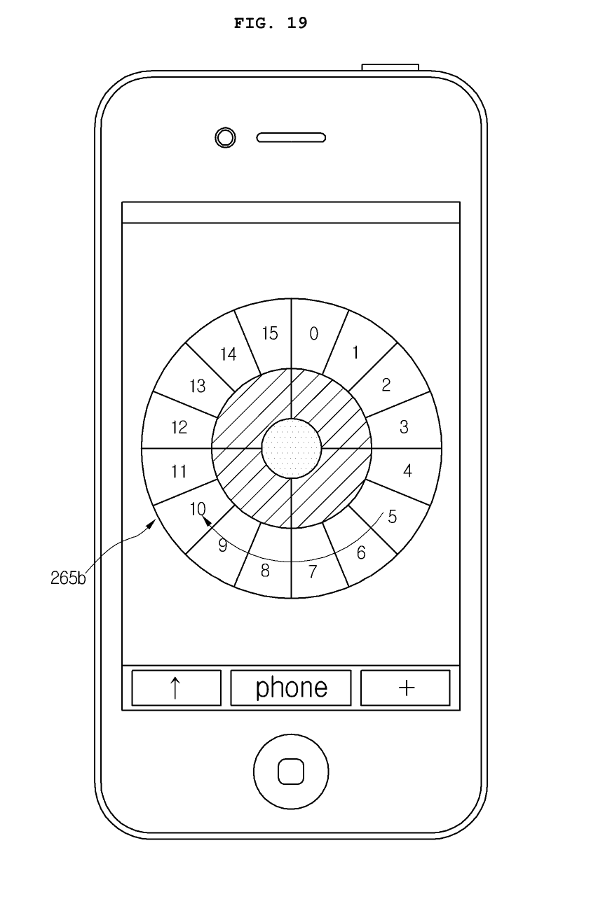

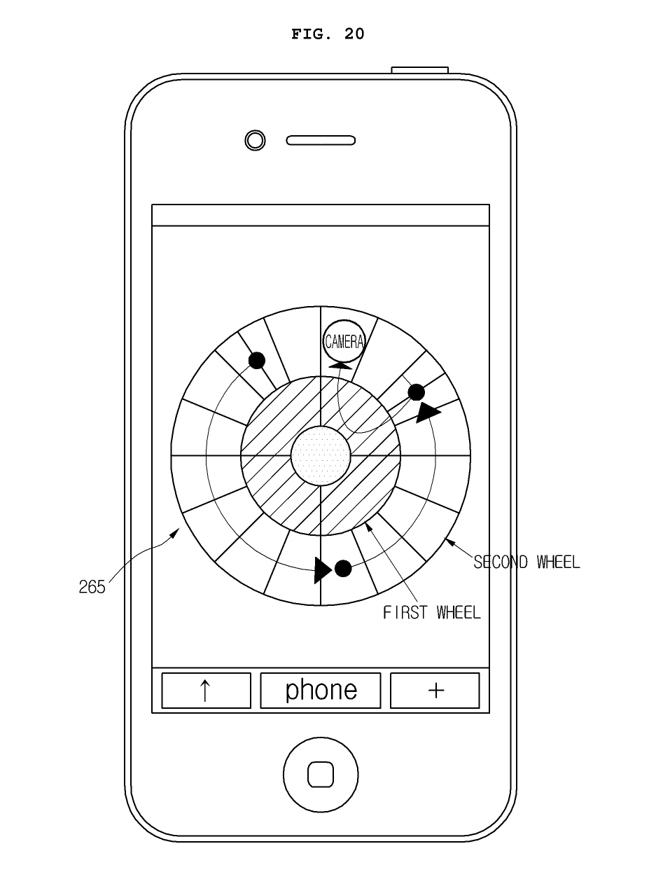

As illustrated in FIG. 19, the password-type screen unlocking unit 265b plays a role in setting a dial number to a cell of the unlocking IW, setting a specific number as a unlocking signal previously, and unlocking a screen if matching the set dial number.

Recognizing the start, intermediate, and end points of a cell of the unlocking IW means setting a cell first touched among cells of the unlocking IW as a start point, setting, as an intermediate point, a cell present an intermediate position of the unlocking IW during continuous finger motion after passing the cell first touched, setting, as an end point, a cell present on the end position of the unlocking IW during continuous finger motion after passing the cell touched on the way, and generating an unlocking signal.

The start, intermediate, and end points of cells of the unlocking IW are designated after a user encrypts cells clockwise or counter-clockwise by using continuity of the unlocking IW.

In addition, it is possible to set a screen so that if an unlocking signal is generated due to user touch or gesture, a preset screen is displayed by using it as a control event value.

The wheel screen unlocking unit 265 may execute a preset application immediately after unlocking. As illustrated in FIG. 20, if a finger gets out of a second wheel following a finger motion for unlocking touch, moves to a first wheel, touches an application to be executed and then is detached from it, it is possible to immediately execute the application which the finger last touches.

In addition, the wheel screen unlocking unit 265 may generate a new IW by drilling out a specific sector immediately after unlocking. For example, if a finger is last detached from a first wheel region of a sector to be drilled out following a finger motion for unlocking touch, a corresponding sector is drilled out and thus it is possible to generate a new IW.

The wheel screen unlocking unit 265 may perform a function of a partition encryption setting unit 265c that encrypts to hide a screen of a specific sector, wheel, and cell of an unlocking IW or data objects included in the screen.

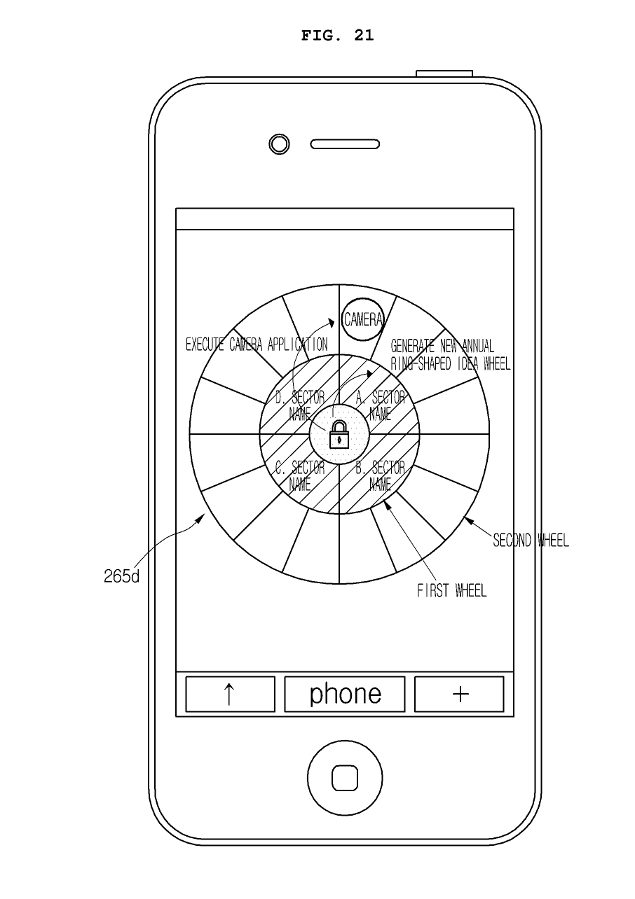

As illustrated in FIG. 21, the wheel screen unlocking unit 265 may perform a function of a direct application executing unit 265d that immediately generates a sector as a new IW or moves immediately to a desired application executing screen, if a screen is initially unlocked without setting a password/pattern.

The direct application executing unit executes a corresponding application by making only a first wheel, a second wheel or a sector name appear through setting or by making frequently used applications appear on a second wheel.

Operations of an IW logic structure based IW application module according to the present invention will be described.

First, a main screen that includes an IW is generated on a screen of a smart phone that is a portable electronic device.

For reference, in order to more efficiently display a main screen including an IW in a limited display area of a smart phone in the present invention, the number of sectors is set as four, namely, ‘A’ to ‘D’ sectors, and the number of wheels is set as three. A wheel closest to a home portion is set as a first wheel which includes four cells that are ‘game’, ‘music’, ‘office’, and ‘contact’, a wheel second closest to the home portion is set as a second wheel which includes 16 cells including folders and icons, and a wheel third closest to the home portion is set as a third wheel which includes 16 cells including folders and icons, as an example.

In this case, each cell includes a data object that includes a text, music, a song, an image, an icon, a moving picture, a file, a folder, and content.

The present embodiment describes on the basis of a folder and an icon among the data objects.

The folder stores files to enable a user to easily recognize them, and a 2 point display area corresponding to two cells of an IW is set to the folder through a folder square setting unit.

That is, if the data object is the folder, higher folders with masters are formed in each cell of the first and second wheels.

The icon is formed as an image to enable a user to easily recognize a file, and a 1 point display area corresponding to one cell of an IW is set to the icon through an icon square setting unit.

That is, if the data object is the icon, icons with slaves of higher folders are formed in each cell of the second and third wheels.

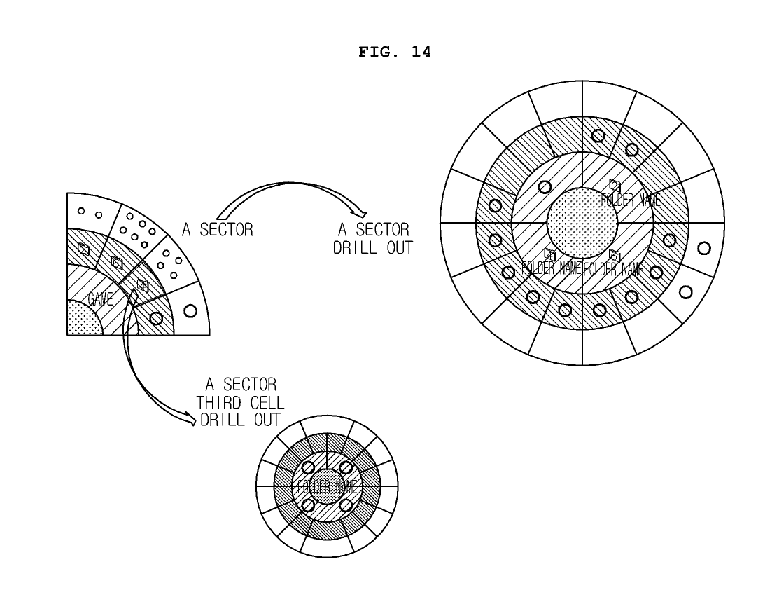

Subsequently, when an ‘A’ sector of an IW (referred to hereinafter as a first IW) displayed on a screen is drilled out through a drill out unit, a ‘game’ master of a first wheel in the same sector of the first IW, a master including folders and icons of a second wheel, and a master including icons of a third wheel are entirely extracted and a second IW which is new is generated, as illustrated in FIG. 14.

In this case, the new wheel switch unit runs, a ‘game’ master of the first wheel of the first IW is formed in the home portion of the second IW, slaves including folders and icons of the second wheel of the first IW are one-to-one formed in the first wheel of the second IW clockwise in order, and slaves including icons of the third wheel of the first IW are one-to-one formed in the second wheel of the second IW clockwise in order.

In addition, when a folder positioned in a cell of a third column of an ‘A’ sector of an IW (referred to hereinafter as a first IW) displayed on the current screen is drilled out through the drill out unit, slaves including ‘4’ higher folders of the second wheel in the same sector of the first IW and icons of the third wheel are entirely extracted and a second IW which is new is generated, as illustrated in FIG. 14.

In this case, the new wheel switch unit runs, a name of ‘4’ higher folders is formed in the home portion of the second IW, slaves including icons of the third wheel of the first IW are one-to-one formed in the first wheel of the second IW clockwise in order, and a slave including icons of the third wheel of the first IW is one-to-one formed in the second wheel of the second IW clockwise in order.

In addition, if the application executing unit runs and an icon formed as an image on a cell of an IW is clicked on a display screen, a control action is taken according to an event value set to the icon to execute a specific application corresponding to the icon.

In addition, through the spin controller unit, a specific sector is positioned on one side of the lower part of a display screen and a setting is performed to makes a wheel and a sector spin rotation around a home portion. In this case, a control operation is performed to move the specific sector from an IW displayed on the current screen to a sector of another IW if a specific sector is selected, and to move a specific cell from an IW displayed on the current display screen to a cell of another IW if the specific cell is selected.

In addition, if a home key is clicked through the home key return unit, a control operation is performed to return from an IW with a lower folder, namely, a data object of a slave displayed on the current screen, to an IW with the top level folder, namely, a data object of a master.

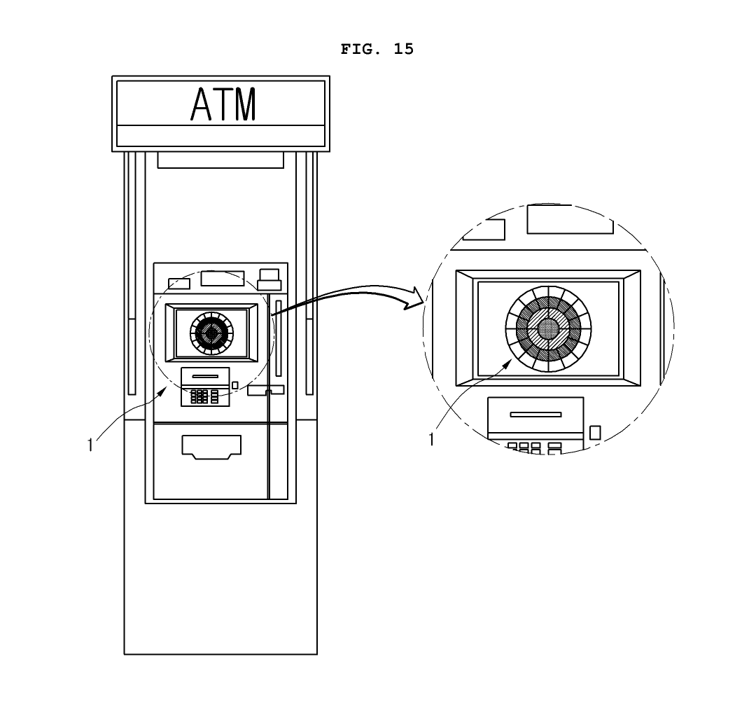

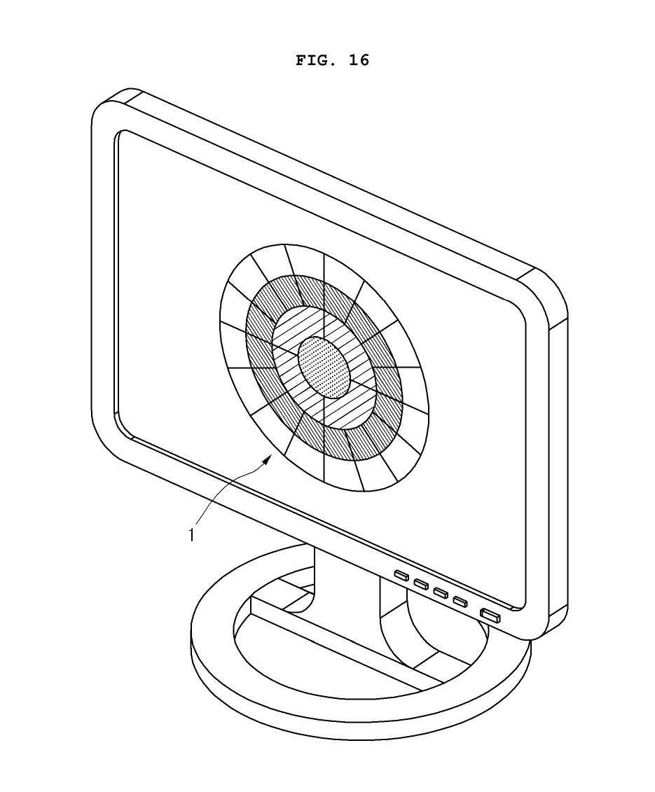

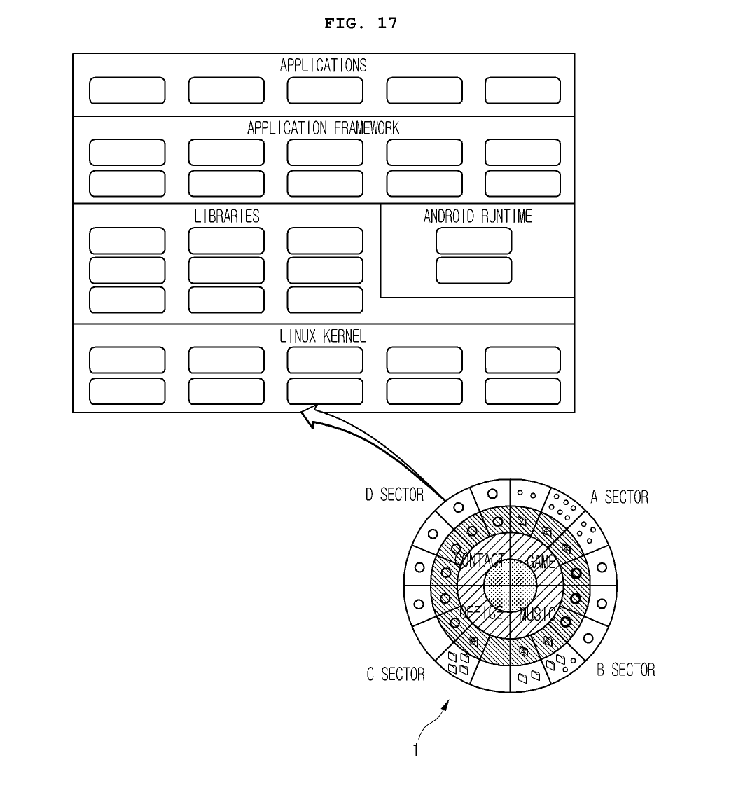

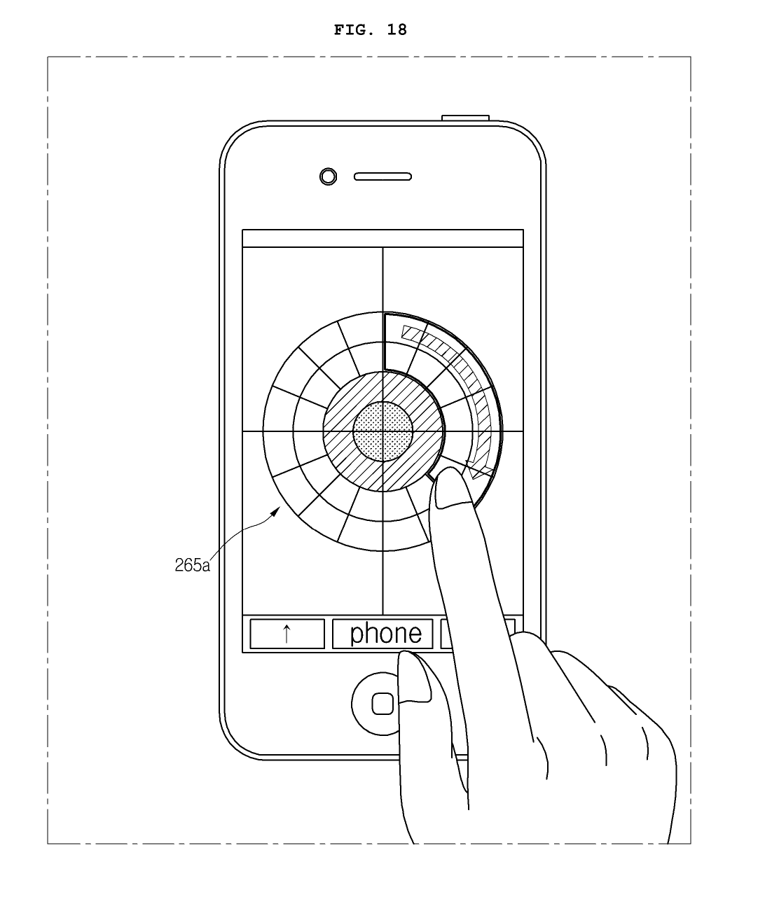

As described above, an IW logic structure based IW application module according to the present invention may be applied to an automatic teller machine (ATM) of display devices as illustrated in FIG. 15 or to a personal computer (PC) monitor of display devices as illustrated in FIG. 16.

In addition, FIG. 17 relates to a system structure in which the IW logic structure based IW application module according to the present invention accesses an android based smart phone system structure (an application, an application framework, a library, android runtime, Linux kernel) of display devices and generates, as a UI, an IW that gradually expands an annual ring-shaped wheel outward from the starting point on a screen of a smart phone.

In addition, the IW logic structure based IW application module according to the present invention accesses any one of Mac, Linux, Unix, Window based smart phone system structures in addition to the android based smart phone system structure and generates, as an UI, an IW that gradually expands an annual ring-shaped wheel outward from the starting point on a screen of a smart phone.

By using an electronic device and a method being implemented by a computer, there are advantages that it is easy to keep and classify data objects and it is easy for a user to access desired data in a limited screen size.

### INDUSTRIAL APPLICABILITY

The present invention has industrial applicability because it is applicable to an electronic device with a display unit.

What is claimed is:

1. An electronic device comprising:
a display unit; and
a user interface (UI) indicating unit indicating a wheel-structure UI with at least one concentric circle on the display unit, wherein the UI indicating unit comprises:
a wheel logic structure unit setting a coordinate system of X axis and Y axis on the basis of a reference point, setting a sector that is a region divided by the X axis and the Y axis, and arranging at least one wheel UI in the sector, and
a wheel control unit enabling the wheel UI to be edited.

2. The electronic device according to claim 1, wherein the wheel control unit enables setting a data object in a wheel close to the reference point as a master in the wheel-structure UI and setting a data object in an outer wheel as a slave, and enables the wheel-structure UI to be edited according to the order of the master and the slave if there is an access to data by a user.

3. The electronic device according to claim 2, wherein the wheel control unit separates a sector or a wheel selected from the wheel-structure UI to generate a new wheel-structure UI if a preset user command is input.

4. The electronic device according to claim 3, wherein the display unit is a touch sensing display capable of sensing user touch, and the wheel control unit generates a new wheel UI on the basis of master and slave classification on a data object stored in a selected sector or wheel if preset user multi-touch is input.

5. The electronic device according to claim 1, wherein the wheel logic structure unit includes the reference point, and displays a home icon through which a name or an image of a master is displayed, and at least one annual ring-shaped wheel image around the home icon,
the annual ring-shaped wheel includes at least one cell and each cell stores at least one data objects, and
the data object includes one or more of a text file, a music file, a 2D or 3D file, and content.

6. The electronic device according to claim 5, wherein the wheel logic structure unit divides the wheel-structure UI into sectors divisible into at least two regions on the basis of the XY coordinate system, and
the wheel control unit selectively edits the annual ring-shaped wheel or the sector region in the wheel-structure UI to have a new wheel-structure UI.

7. The electronic device according to claim 1, wherein the UI indicating unit selects and accesses any one of Mac, Linux, Unix, and Window based system structures, and then, generates and displays a wheel UI that includes the at least one annual ring-shaped wheel.

8. The electronic device according to claim 1, wherein the display unit is a display device of any one of a smart phone, a PC monitor, a cash dispenser, a TV monitor, a tablet PC, an MP3 player, an E-book reader, and a game machine.

9. A method being implemented by a computer,
in an electronic device including a display unit,
displaying a wheel-structure UI that includes a home region serving as a reference point of the display unit and at least one annual ring-shaped wheel around the home region;
if there is a request for storing the data object, storing a data object by a cell forming the wheel, and classifying the data object as a master and a slave of the data object according to a wheel position of a corresponding cell; and
if there is a request for editing the wheel-structure UI, rotating the wheel or generating, by a sector unit dividing the wheel-structure UI into at least two regions, data objects in a corresponding sector, as a new wheel-structure UI.

10. The method according to claim 9, wherein the generating of the data objects as the new wheel-structure UI is performed if the display unit is a display device which enables a touch input, and a touch path or multi-touch preset from a user is input.

11. The method according to claim 10, wherein the generating of the data objects as the new wheel-structure UI is performed on any one of the annual ring-shaped wheels or by a sector unit given when the wheel-structure UI is divided by an XY coordinate system.
